(19) United States
(12) Patent Application Publication
(10) Pub. No.: US 2025/0057357 A1
(43) Pub. Date: Feb. 20, 2025

(54) CARBONATION MACHINE

(71) Applicant: Sodastream Industries Ltd., Kfar Saba (IL)

(72) Inventors: Oren David SHALEV, Ashdod (IL); Igor KUROVETS, Ashdod (IL); Guy MEGIDISH, Kiryat Gat (IL); Dvir BRAND, Hod-Hasharon (IL); Gal SHNER, Kohav Michael (IL); Jacob COHEN, Haifa (IL)

(73) Assignee: Sodastream Industries Ltd., Kfar Saba (IL)

(21) Appl. No.: 18/233,865

(22) Filed: Aug. 14, 2023

(51) Int. Cl. A47J 31/58; A23L 2/54; A47J 31/44; A47J 31/46

(52) U.S. Cl. CPC A47J 31/58; A23L 2/54; A47J 31/4403; A47J 31/4425; A47J 31/461

(57) ABSTRACT

A carbonation machine may include a carbonation head with a bottle holder configured to hold a bottle with water to be carbonated and inject carbon dioxide into the bottle; and a safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level.

### FIELD OF THE INVENTION

The present invention relates to carbonation machines. More particularly, the present invention relates to a carbonation machine with a novel carbonation head.

### BACKGROUND OF THE INVENTION

Carbonation machines are commonly used in homes, offices, cafeterias, and other settings.

Typically, a carbonation machine is designed to carbonate water or other liquid contained in a bottle that is sealingly attached to the carbonation head of the carbonation machine to prevent inadvertent pressure release from the bottle. In the carbonation process carbon dioxide is injected as a jet (having a typical pressure of some 60 bars) into the water to obtain a sparkling beverage. The injected carbon dioxide creates turbulence in the bottle allowing good distribution and absorption of carbon dioxide in the water, while excess gas is released. Pressure built-up above the water surface inside the bottle may typically be released via designated one or more pressure release valves. When the carbonation process is over the bottle with the carbonated beverage may be removed from the carbonation head of the carbonation machine. For example, the removal of the bottle from the carbonation head is carried out by tilting the bottle to actuate a pressure release mechanism or another arrangement for quick release of gas to release excess pressure from within the bottle. The release of excess gas prior to the removal of the bottle from the carbonation machine is usually uncontrolled.

The height of the carbonation machine typically corresponds to the height of the gas canister that is attached to the carbonation head and provides carbonating gas (e.g., carbon dioxide) for the carbonation process, and the structure of the carbonation head that contributes some additional height.

In many households carbonation machines are stored and used in the kitchen. As the kitchen space for various home appliances may be limited it may be desired to provide a carbonation machine with a carbonation head whose extra height above the height of the typical gas canister is limited and/or minimal.

### SUMMARY OF THE INVENTION

There is thus provided, in accordance with an embodiment of the invention, a carbonation machine that includes a carbonation head with a bottle holder configured to hold a bottle with water to be carbonated and inject carbon dioxide into the bottle; and a safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level.

According to some embodiments of the present invention, the first spring operated piston and the second spring operated piston of the safety dual valve assembly are coaxially movable.

According to some embodiments of the present invention, a spring is provided to force the first spring operated piston and the second spring operated piston away from each other to hold the pistons in closed positions.

According to some embodiments of the present invention, an effective sealing area of the first spring operated piston is different than an effective sealing area of the second spring operated piston.

According to some embodiments of the present invention, the effective sealing area of the first spring operated piston and the effective sealing area of the second spring operated piston are defined by gaskets of different dimensions.

According to some embodiments of the present invention, the carbonation machine is further provided with a burst disk protected valve configured to burst and release excess pressure at a third pressure threshold level that is higher than the second pressure threshold level.

According to some embodiments of the present invention, the carbonation machine further includes an actuator for actuating the first spring operated piston and the second spring operated piston so that each of the pistons is forced to break a seal.

According to some embodiments of the present invention, the carbonation head is rotatable between a tilted position and an upright position.

According to some embodiments of the present invention, the rotatable carbonation head includes a convex back surface matching a concave surface of a stationary part of the carbonation machine.

According to some embodiments of the present invention, the carbonation head comprises at least one cam presenting to the second spring operated piston an initially retracted surface that gradually draws closer to the convex back surface, and wherein the second spring operated piston comprises at least one protrusion facing and in contact with the at least one cam, so that when the carbonation head is rotated to the dismounting position the second spring operated piston is forced to break the seal.

According to some embodiments of the present invention, the bottle holder comprises an annular indentation into which a bottle neck ring of the bottle may sink so as to lock and firmly hold the bottle in position.

According to some embodiments of the present invention, the bottle holder comprises two substantially opposite arms, and wherein each arm includes a semi-annular indentation so that together the arms form the annular indentation.

According to some embodiments of the present invention, a valve actuator is provided, linked to the first spring operated piston configured to be guided through a guiding track, so that when the rotatable carbonation head is rotated to the dismounting position the first spring operated piston is forced to break a seal and release excess pressure.

According to some embodiments of the present invention, there is provided a carbonation head for a carbonation machine with a bottle holder configured to hold a bottle with water to be carbonated and inject carbon dioxide into the bottle; and a safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level.

According to some embodiments of the present invention, there is provided a safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level.

According to some embodiments of the present invention, there is provided a safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level, the safety dual valve assembly further comprising an actuator for actuating the first spring operated piston and the second spring operated piston so that each of the pistons is forced to break a seal.

### BRIEF DESCRIPTION OF THE DRAWINGS

In order for the present invention to be better understood and for its practical applications to be appreciated, the following Figures are provided and referenced hereinafter. It should be noted that the Figures are given as examples only and in no way limit the scope of the invention. Like components are denoted by like reference numerals.

FIG. 1 shows a carbonation machine according to some embodiments of the present invention, with a compact safety dual valve assembly.

FIG. 2 shows a bottle neck ring holder for a carbonation machine, according to some embodiments of the present invention.

FIG. 3 shows a bottle holder for a carbonation machine, according to some embodiments of the present invention, with a bottle spout inserted into the holder.

FIG. 4 shows the bottle holder of FIG. 3, with a bottle spout locked in a secured position by the holder.

FIG. 5 is a cross-sectional view of a carbonation head and a safety dual valve assembly, according to some embodiments of the present invention, in a carbonation position.

FIG. 6 is a cross-sectional detailed view of the carbonation head and the safety dual valve assembly of FIG. 5, in a carbonation position.

FIG. 7 is a cross-sectional detailed view of the carbonation head and the safety dual valve assembly of FIG. 5, in a bottle dismounting position.

FIG. 8 is a side view of the carbonation head and the safety dual valve assembly of FIG. 5, in a bottle dismounting position.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

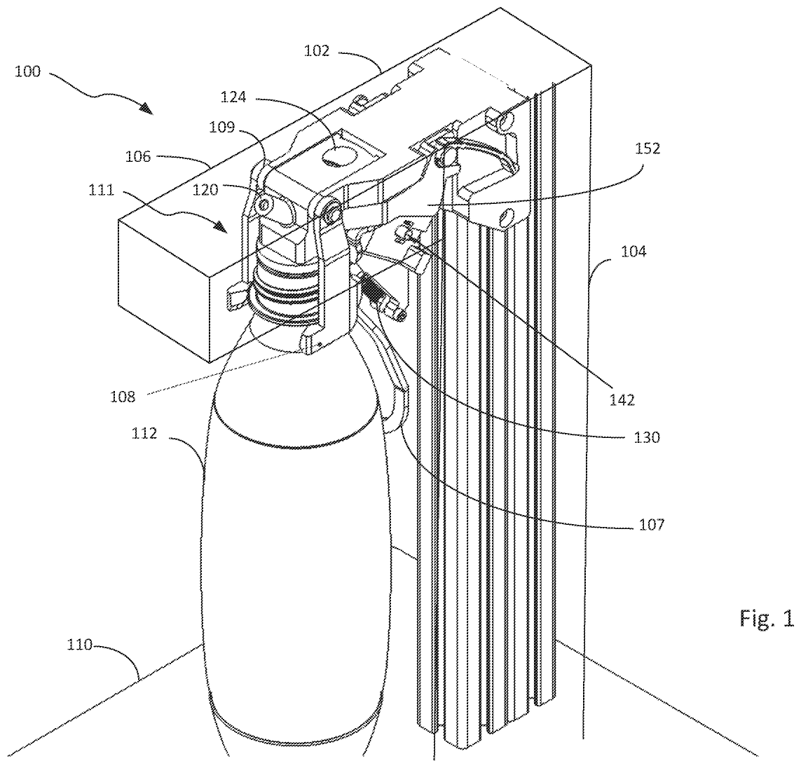

FIG. 1 shows a carbonation machine 100, according to some embodiments of the invention, with a compact safety dual valve assembly.

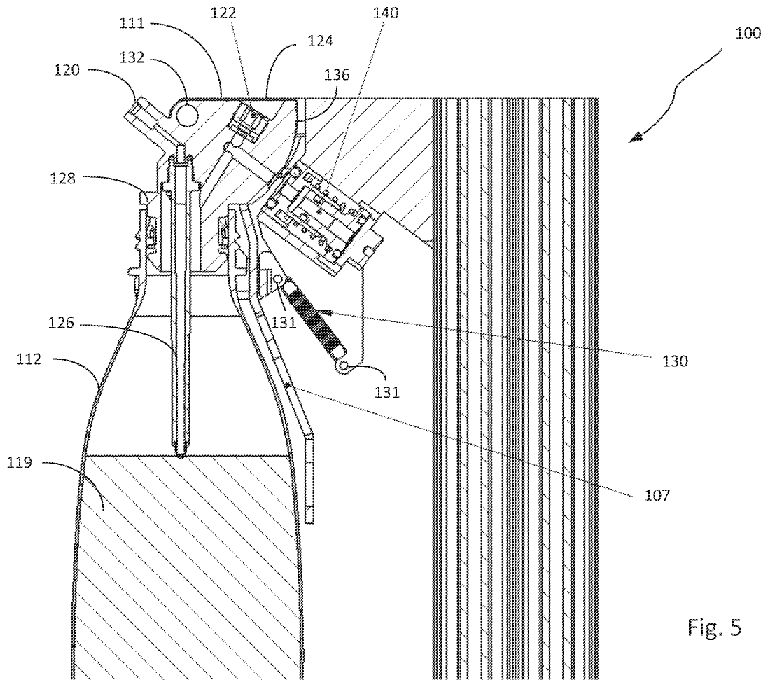

Carbonation machine 100 includes base 110 and housing 102, that appears transparent in the Figures to allow viewing of internal parts. Housing 102 includes column 104 that includes a hidden compartment for a gas canister (not shown) and carbonation head compartment 106 for housing carbonation head 111. Carbonation head 111 is configured to receive the spout of bottle 112 filled up to a preferred threshold with water, and hold it firmly while injecting carbon dioxide into the bottle using a carbonation tube (see 126 in FIG. 5) which is inserted into the bottle, when the spout 113 of bottle 112 is held by bottle neck ring holder 108 of the carbonation head. When it is desired to carbonate the water inside the bottle, the bottle is attached to the bottle neck ring holder 108 and upon actuation of the carbonation mechanism (e.g., pressing a button or rotating a lever) carbon dioxide from the gas canister flows via piping (not shown, for brevity) into inlet 120 and through carbonation tube 126 into the bottle. When carbonation is completed, excess pressure inside the bottle may be manually released by rotating the bottle 112 with the bottle neck ring holder 108 so as to unblock exhaust outlet 150 of exhaust path 148 and allow excess pressure to be released through the exhaust outlet. More information on that is hereinafter provided with reference to the relevant figures.

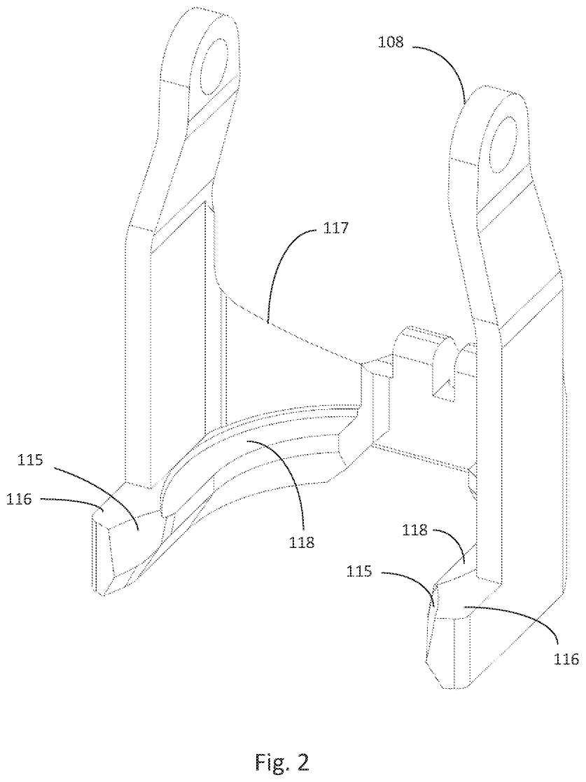

FIG. 2 shows a bottle neck ring holder 108 for a carbonation machine, according to some embodiments of the present invention. Body 117 of bottle neck ring holder 108 defines a confined space within defined between substantially opposite arms 116 which is designed to accommodate spout 113 of bottle 112. Arms 116 may each include a leading edge 115, presenting together a tapered zone into which spout 113 of bottle 112 may be inserted. Bottle support arm 107 may be rigidly connected to the rotatable carbonation head so as to provide support for the back of the bottle when it is placed inside the bottle neck ring holder 108. Arms 116 are designed to present an annular indentation 118 which is designed to accommodate the bottle neck ring 114 about spout 113 of bottle 112, such that when bottle neck ring 114 sinks into the annular indentation 118 it is firmly held preventing release removal of the bottle 112 from the bottle neck ring holder 108, unless it is raised up first and pulled out. For example, each arm 116 of botte neck ring holder 108 may be configured to present a semi-annular indentation 118, so that together the two arms present annular indentation 118.

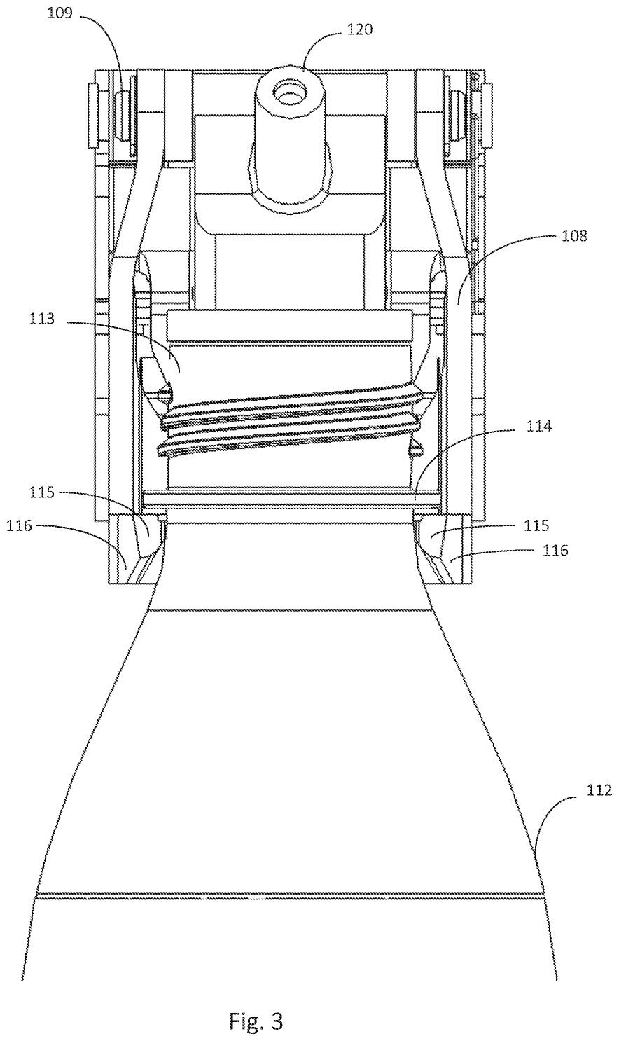

FIG. 3 shows a bottle neck ring holder 108 for a carbonation machine, according to some embodiments of the present invention, with spout 113 inserted into the holder. This is an initial position of the bottle within neck ring holder 108, as the spout 113 is placed within the zone defined between arms 116, but bottle neck ring 114 is not yet locked in position inside the substantially opposite semi-annular indentations 118.

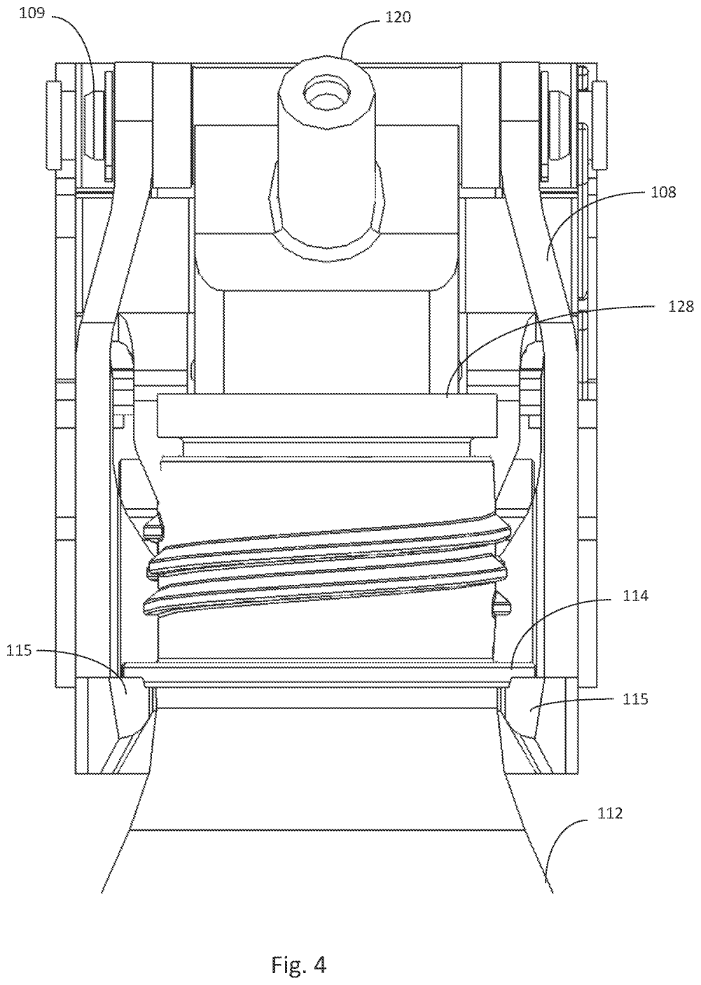

FIG. 4 shows the bottle neck ring holder of FIG. 3, with a bottle spout locked in a secured position by the holder. In this position bottle neck ring 114 of bottle 112 is now locked in position inside the substantially opposite semi-annular indentations 118. This position may be affected when the carbonation process commences, during which pressure built-up inside bottle 112 causes bottle neck ring 114 of bottle 112 to sink into substantially opposite semi-annular indentations 118, thereby locking the bottle spout in position and holding it firmly. Carbonation tube barrel 128 may be provided, designed to closely fit inside bottle spout 113 and cork the bottle to prevent inadvertent pressure release from the bottle during the carbonation process.

FIG. 5 is a cross-sectional view of a carbonation head and a safety dual valve assembly 140, according to some embodiments of the present invention, in a carbonation position.

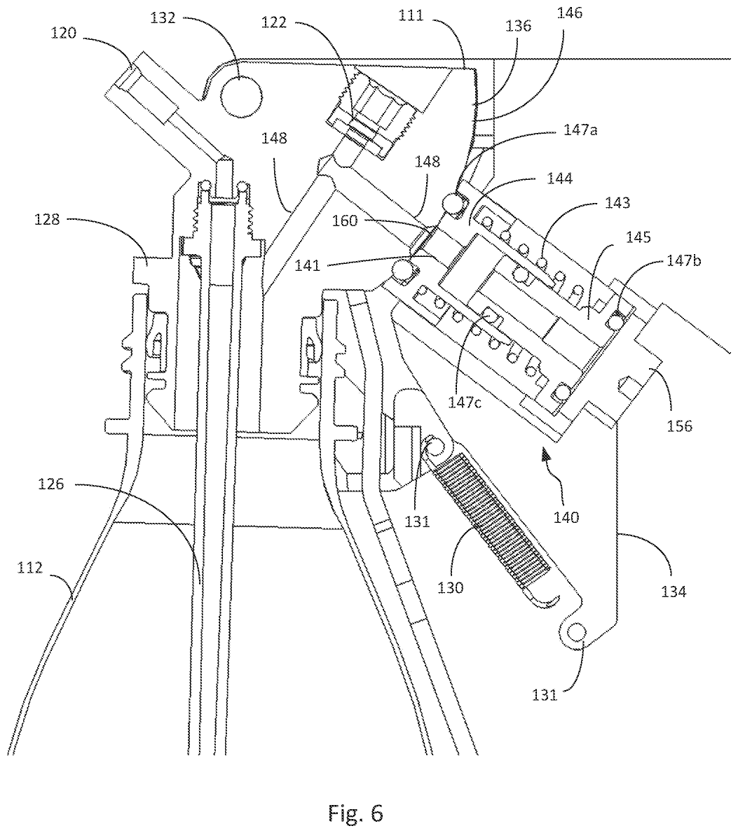

FIG. 6 is a cross-sectional detailed view of the carbonation head and the safety dual valve assembly of FIG. 5, in a carbonation position.

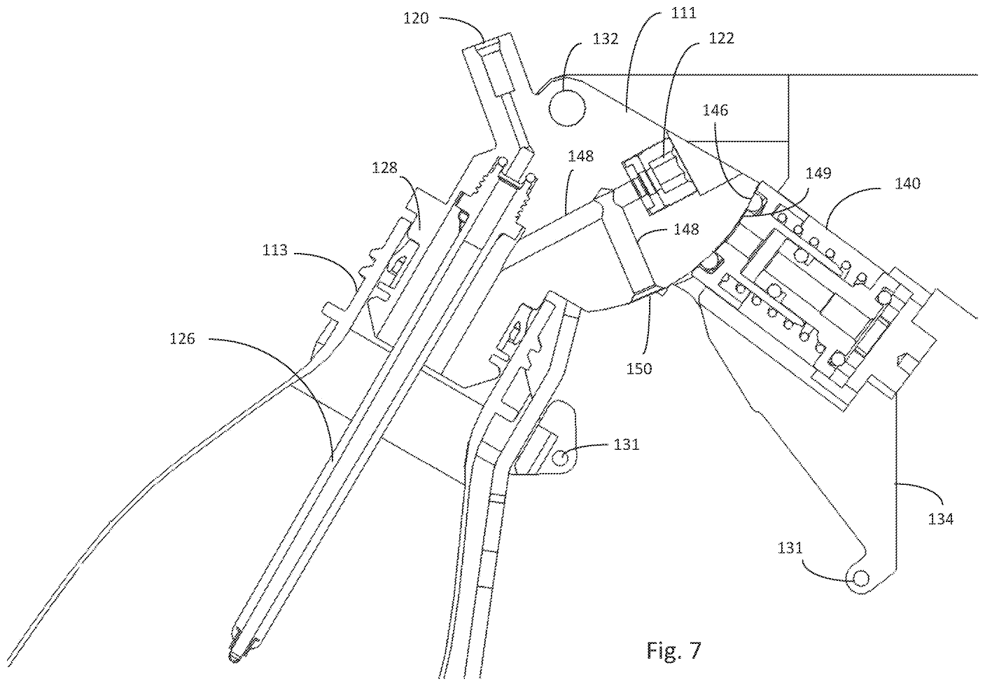

FIG. 7 is a cross-sectional detailed view of the carbonation head and the safety dual valve assembly of FIG. 5, in a bottle dismounting position.

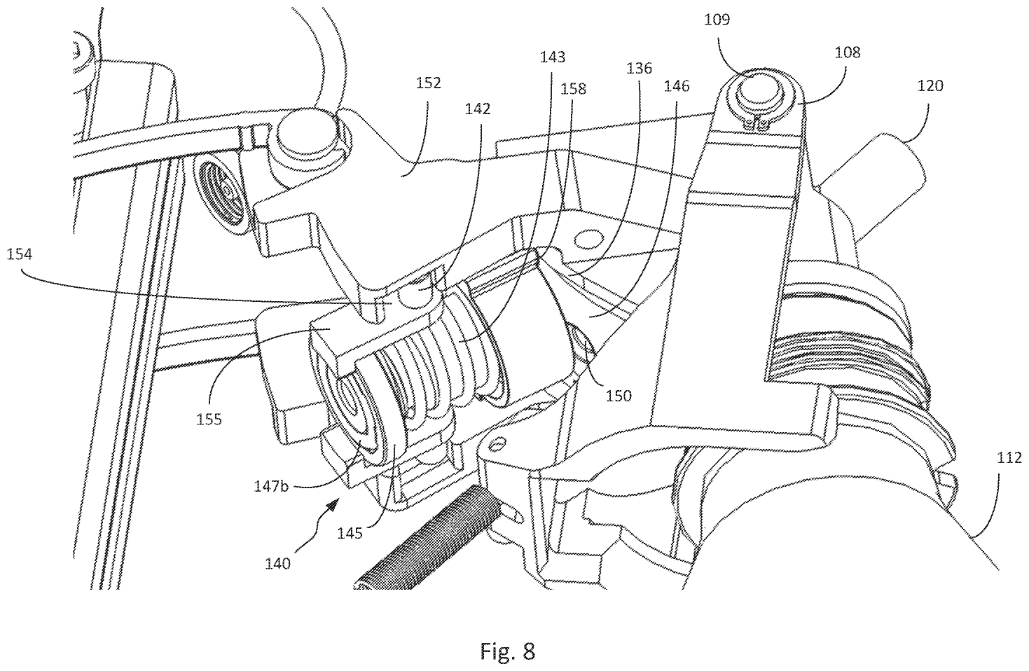

FIG. 8 is a side view of the carbonation head and the safety dual valve assembly of FIG. 5, in a bottle dismounting position.

Safety dual valve assembly 140 incorporates two pressure release valves that are combined in a single relatively tight assembly, saving space and parts.

In the embodiment shown in the Figures safety dual valve assembly 140 is located in a stationery portion of the carbonation machine, adjacent to the rotatable carbonation head 111. Carbonation head 111 may be configured to be rotated about rotation axle 109 (bore 132 may be provided for accommodating such an axle) and present a convex back surface designed to match a concave surface 149 of the stationary portion of the carbonation machine.

Safety dual valve assembly 140 comprises two cooperating valves, which are designed to give in and release excess pressure built-up at different excess pressure levels. This is made possible, for example, by designing a dual valve assembly which includes two coaxially movable pistons 144 and 145, each of which the effective sealing area is defined by the contact surface of their gaskets 147a and 147b, respectively, and shared gasket 147c.

The two movable pistons 144 and 145 are both pressed away from each other by a common spring 143, so that concave surface 149 of piston 144 sealingly covers convex back 146 of carbonation head 111 and vent 160, and piston 145 sealingly covers the facing surface of piston back 156.

The safety dual valve assembly is designed to facilitate pressure release at two different pressure thresholds. At a first pressure threshold piston 145 is designed to slide causing gasket 147h to disengage from piston back 156, opening a gap through which excess pressure may be released, while at a second pressure threshold, which is higher than the first pressure threshold, piston 144 is designed to cause gasket 147a to disengage from convex back 146 of carbonation head 111 and uncover vent 160. This is made possible by designing the effective sealing surfaces of the gaskets of the pistons to be different so as to react to different pressure levels.

For the lower pressure release the difference in the contact surface between 147b and 147c causes seal 147b to open. For the higher pressure release the difference in the contact surface between 147a and 147c causes seal 147a to open.

When excess pressure from within bottle 112 vents out via exhaust path 148, and into the internal space 141 of valve assembly 140 pressure starts to build up inside valve assembly 140. The force that is applied by the spring multiplied by the effective sealing area determines the pressure applied on the piston, and because the different effective sealing areas of the two gaskets owing to their different dimensions, the piston with the smaller gasket is configured to give in and allow pressure to be released at a first pressure threshold that is lower than a second pressure release threshold of the other piston and its bigger gasket.

Thus, safety valve assembly 140 is configured to release excess pressure via first piston 145 when reaching the first pressure threshold. If, for some reason (e.g., the first piston is stuck, for example because of the existence of sticky sugar residues) the pressure within the internal space 141 of safety valve assembly 140 may rise further until it reaches the second pressure threshold at which the second piston will give in and release the excess pressure.

If, for some reason, the second piston fails to act and does not release the pressure build-up causing further pressure build up, a burst disk protected valve 122 is also provided, that is designed to burst at a third pressure threshold (e.g., higher than the second pressure threshold) and release the excess pressure through outlet 124.

Spring 130 may be provided, connected to bore 131 on a pull arm 134 forming a part of the stationary part of the carbonation machine and to bore 131 on the rotatable carbonation head, so as to force rotatable carbonation head 111 back to assume an up-right position. In FIG. 6 spring 130 is shown detached from one of the spring holding bores 131. This is just to show that in its default position spring 130 is shorter then when linked to bores 131, to illustrate that it is designed to pull the rotatable carbonation head from a tilted position to assume an upright position. In FIG. 7 spring 130 is not shown for brevity.

Valve actuator 142 (see FIG. 1, FIG. 8) is provided, linked to piston 145, to controllably operate moving piston 145 to momentarily break a seal (e.g., the sealed gaskets) during the dismounting of the bottle from the carbonation machine so as to ensure proper functioning of the safety dual valve assembly.

When rotating bottle 112 away from the carbonation up-right position to the dismounting position, valve actuator 142 is caused to be guided through guiding track 154 of side wing 152, that is fixedly connected to bottle neck ring holder 108. Guiding track 154 is fixed to valve actuator 142 and is designed to force valve actuator 142 to be pulled so as to cause piston support 155, to which valve actuator 142 is firmly connected, to pull piston 145 so as to disengage it from piston back 156. Carbonation head 111 is also designed, during the rotation of bottle 112 to the dismounting position to cause concave surface 149 of piston 144 to disengage from convex surface 146 This can be made possible, for example, by designing the back of carbonation head 111 to present at least one cam 136, e.g., two such cams on either sides of convex back 146, that present to piston 144 an initially retracted surface (with respect to convex back 146, when the bottle is maintained in the carbonation position) that gradually draws closer to the surface of convex back 146 until it is fully flush with the convex back 146, as carbonation head 111 is rotated. First piston 144 has at least one, e.g., two protrusions, 158 on the top of the part facing and in contact with each of cams 136. Thus, when the bottle neck ring holder 108 (and carbonation head 111) is rotated from the carbonation position to the disengagement position the narrow cams push the protrusions 158 so as to force first piston 144 to break the seal made by gasket 147a and release excess pressure.

The overall height of the carbonation machine, in accordance with embodiments of the present invention, may be greatly reduced when placing most parts of the machine at the same height level or lower than the rotation axle of the carbonation head. The height of the carbonation machine greatly depends on the height of the gas canister, but avoiding placing parts above that height can be useful in maintaining the carbonation machine as small as possible.

Following is an index of elements shown in the figures:
100—carbonation machine;
102—housing;
104—column with gas canister compartment;
106—carbonation head compartment;
107—bottle support arm;
108—bottle neck ring holder;
109—rotation axle of bottle neck ring holder (and carbonation head 111);
110—base;
111—carbonation head;
112—bottle;
113—bottle spout;
114—bottle neck ring;
115—leading edge;
116—bottle holder arms;
117—bottle holder body;
118—lock-in semi-annular indentation;
119—water;
120—carbon dioxide inlet;
122—burst disk protected valve;
124—burst disk protected valve outlet;
126—carbonation tube;
128—carbonation tube barrel;
130—spring;
131—spring attachment bore;
132—bore;
134—spring pull arm;
136—cam;
140—safety dual valve assembly;
141—valve assembly internal space;
142—valve actuator;
143—valve spring;
144—first piston;
145—second piston;
146—convex back;
147a, 147b, 147c—gaskets;
148—exhaust path;
149—concave surface;
150—exhaust outlet;
152—side wing;
154—guiding track;
155—piston support;
156—piston back;
158—protrusion;
160—vent.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fail within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A carbonation machine comprising:
a carbonation head with a bottle holder configured to hold a bottle with water to be carbonated and inject carbon dioxide into the bottle; and
a safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level.

2. The carbonation machine of claim 1, wherein the first spring operated piston and the second spring operated piston of the safety dual valve assembly are coaxially movable.

3. The carbonation machine of claim 1, wherein a spring is provided to force the first spring operated piston and the second spring operated piston away from each other to hold the pistons in closed positions.

4. The carbonation machine of claim 3, wherein an effective sealing area of the first spring operated piston is different than an effective sealing area of the second spring operated piston.

5. The carbonation machine of claim 4, wherein the effective sealing area of the first spring operated piston and the effective sealing area of the second spring operated piston are defined by gaskets of different dimensions.

6. The carbonation machine of claim 1 further provided with a burst disk protected valve configured to burst and release excess pressure at a third pressure threshold level that is higher than the second pressure threshold level.

7. The carbonation machine of claim 1 further comprising an actuator for actuating the first spring operated piston and the second spring operated piston so that each of the pistons is forced to break a seal.

8. The carbonation machine of claim 1, wherein the carbonation head is rotatable between a tilted position and an upright position.

9. The carbonation machine of claim 8, wherein the rotatable carbonation head includes a convex back surface matching a concave surface of a stationary part of the carbonation machine.

10. The carbonation machine of claim 9, wherein the carbonation head comprises at least one cam presenting to the second spring operated piston an initially retracted surface that gradually draws closer to the convex back surface, and wherein the second spring operated piston comprises at least one protrusion facing and in contact with the at least one cam, so that when the carbonation head is rotated to the dismounting position the second spring operated piston is forced to break the seal.

11. The carbonation machine of claim 1, wherein the bottle holder comprises an annular indentation into which a bottle neck ring of the bottle may sink so as to lock and firmly hold the bottle in position.

12. The carbonation machine of claim 11, wherein the bottle holder comprises two substantially opposite arms, and wherein each arm includes a semi-annular indentation so that together the arms form the annular indentation.

13. The carbonation machine of claim 9, wherein a valve actuator is provided, linked to the first spring operated piston configured to be guided through a guiding track, so that when the rotatable carbonation head is rotated to the dismounting position the first spring operated piston is forced to break a seal and release excess pressure.

14. A carbonation head for a carbonation machine with a bottle holder configured to hold a bottle with water to be carbonated and inject carbon dioxide into the bottle; and
a safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level.

15. The carbonation head of claim 14, wherein the first spring operated piston and the second spring operated piston of the safety dual valve assembly are coaxially movable.

16. The carbonation head of claim 14, wherein a spring is provided to force the first spring operated piston and the second spring operated piston away from each other to hold the pistons in closed positions.

17. The carbonation head of claim 16, wherein an effective sealing area of the first spring operated piston is different than an effective sealing area of the second spring operated piston.

18. The carbonation head of claim 17, wherein the effective sealing area of the first spring operated piston and the effective sealing area of the second spring operated piston are defined by gaskets of different dimensions.

19. The carbonation head of claim 17, further comprising an actuator for actuating the first spring operated piston and the second spring operated piston so that each of the pistons is forced to break a seal.

20. The carbonation head of claim 17, wherein the carbonation head is rotatable between a tilted position and an upright position.

21. The carbonation head of claim 20, comprising a convex back surface matching a concave surface of a stationary part of the carbonation machine.

22. The carbonation head of claim 21, configured, when rotated to move the bottle from the upright position to a dismounting position, to force a valve actuator linked to the first spring operated piston to cause the first spring operated piston to break the seal.

23. The carbonation head of claim 22, comprising at least one cam presenting to the second spring operated piston an initially retracted surface that gradually draws closer to the convex back surface until it is fully flush with the convex back surface, and wherein the second spring operated piston comprises at least one protrusion facing the at least one cam, so that when the carbonation head is rotated to the dismounting position the second spring operated piston is forced to break the seal.

24. A safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level.

25. A safety dual valve assembly comprising a first spring operated piston and a second spring operated piston, for releasing excess pressure when the bottle is held by the carbonation head, wherein the first spring operated piston is configured to release excess pressure at a first pressure threshold level and wherein the second spring operated piston is configured to release excess pressure at a second pressure threshold level, wherein the first pressure threshold level is lower than the second pressure threshold level, the safety dual valve assembly further comprising an actuator for actuating the first spring operated piston and the second spring operated piston so that each of the pistons is forced to break a seal.
